(19) United States
(12) Patent Application Publication
(10) Pub. No.: US 2012/0085905 A1
(43) Pub. Date: Apr. 12, 2012

(54) Tandem Time-of-Flight Mass Spectrometer

(75) Inventor: Takaya Satoh, Tokyo (JP)

(73) Assignee: JEOL LTD., Tokyo (JP)

(21) Appl. No.: 13/251,504

(22) Filed: Oct. 3, 2011

(30) Foreign Application Priority Data
Oct. 8, 2010 (JP) 2010-228244

(51) Int. Cl. H01J 49/40

(52) U.S. Cl. 250/287

(57) ABSTRACT

A tandem time-of-flight mass spectrometer having enhanced duty cycle is offered. The inventive mass spectrometer has an ion storage means and a time-calculating means, in addition to the components of a normal tandem time-of-flight mass spectrometer. The time-calculating means finds the time between the instant at which precursor ions are ejected from the ion storage means and the instant at which the ions arrive at a position inside the orthogonal acceleration region where the ions pass into the following first TOF ion optical system at a maximum passage efficiency. The precursor ions are accelerated in a pulsed manner according to the instant at which the ions reach the position giving the maximum passage efficiency.

### BACKGROUND OF THE INVENTION

1. Field of the Invention

The present invention relates to a tandem time-of-flight mass spectrometer used in quantitative analysis and qualitative simultaneous analysis of trace compounds and also in structural analysis of sample ions.

2. Description of Related Art

### [Mass Spectrometers]

A mass spectrometer ionizes a sample in an ion source and separates the resulting ions according to their mass-to-charge ratio (m/z value) in a mass analyzer. The separated ions are detected by a detector. The result is displayed in the form of a mass spectrum in which the m/z value is plotted on the horizontal axis and the relative intensity is plotted on the vertical axis. The m/z values of compounds contained in the sample and their relative intensities are obtained. Consequently, qualitative and quantitative information of the sample can be obtained.

There are various ionization methods, various mass separation methods, and various ion detection methods. The present invention is especially concerned with the mass separation technology. Depending on the principle of mass separation, mass spectrometers are classified into quadrupole mass spectrometer (QMS), ion-trap mass spectrometer (ITMS), magnetic mass spectrometer, time-of-flight mass spectrometer (TOFMS), Fourier-transform ion cyclotron resonance mass spectrometer (FTICRMS), and so on.

### [Time-of-Flight Mass Spectrometer (TOFMS)]

TOFMS is a mass spectrometer for finding the mass-to-charge ratio of an ion by imparting a given amount of energy to the ion to accelerate it such that it travels and by measuring the time taken until the ion reaches a detector. In TOFMS, an ion is accelerated with a given pulsed voltage Vₐ. At this time, from the law of conservation of energy, the velocity v of the ion is given by

$$\begin{matrix}{mv}^{2} / 2 = {qeV}_{a} & ( 1 ) \\ v = \sqrt{\frac{2 qeV}{m}} & ( 2 )\end{matrix}$$

where m is the mass of the ion, q is the electric charge of the ion, and e is the elementary charge. The ion reaches a detector, placed behind at a given distance of L, in a flight time T. The flight time is given by

$$T = L / v = L \sqrt{\frac{m}{2 qeV}} \qquad ( 3 )$$

TOFMS is an instrument that separates masses by making use of the fact that the flight time T differs according to different ion mass m as indicated by Eq. (3). One example of linear TOFMS is shown in FIG. 1. Furthermore, reflectron TOF mass spectrometers capable of providing improved energy focusing and elongating the flight distance by placing a reflectron field between an ion source and a detector are widely used. One example of reflectron TOFMS is shown in FIG. 2.

### [Helical Orbit TOFMS]

The mass resolution of TOFMS is defined to be

$$mass resolution = \frac{T}{2 Δ T} \qquad ( 4 )$$

where T is the total flight time and ΔT is a peak width. That is, if the peak width ΔT is made constant and the total flight time T can be lengthened, the mass resolution can be improved. However, in the related art linear or reflectron type TOFMS, increasing the total flight time T (i.e., increasing the total flight distance) will lead directly to an increase in instrumental size. A multi-pass time-of-flight mass spectrometer has been developed to realize high mass resolution while avoiding an increase in instrumental size (see M. Toyoda, D. Okumura, M. Ishihara and I. Katakuse, J. Mass Spectrom., 2003, 38, pp. 1125-1142). This instrument uses four toroidal electric fields each consisting of a combination of a cylindrical electric field and a Matsuda plate. The total flight time T can be lengthened by accomplishing multiple turns in a figure 8-shaped circulating orbit. In this apparatus, the spatial and temporal spread at the detection surface has been successfully converged up to the first-order term using the initial position, initial angle, and initial kinetic energy.

However, the TOFMS in which ions revolve many times around a closed trajectory suffers from the problem of overtaking. That is, because ions revolve multiple times around a closed trajectory, lighter ions moving at higher speeds overtake heavier ions moving at smaller speeds. Consequently, the fundamental concept of TOFMS that ions arrive at the detection surface in turn from the lightest one does not hold.

The spiral-trajectory TOFMS has been devised to solve this problem. The spiral-trajectory TOFMS is characterized in that the starting and ending points of a closed trajectory are shifted from the closed trajectory plane in the vertical direction. To achieve this, in one method, ions are made to impinge obliquely from the beginning (see JP-A-2000-243345). In another method, the starting and ending points of the closed trajectory are shifted in the vertical direction using a deflector (see JP-A-2003-86129). In a further method, laminated toroidal electric fields are used (see JP-A-2006-12782).

Another TOFMS has been devised which is based on a similar concept but in which the trajectory of the multi-pass TOFMS (see GB2080021) where overtaking occurs is zigzagged (see WO2005/001878 pamphlet).

### [Combination of Ion Source and Acceleration Method]

Ion acceleration methods used in TOFMS are classified into two major categories which are herein referred to as the first acceleration method and the second acceleration method, respectively. In the first ion acceleration method, sample ions obtained by ionizing a sample in a pulsed manner are accelerated in the direction of TOFMS. A representative technique is MALDI-TOFMS. In this method, most of ions created in synchronism with measurement of the time of flight are analyzed, and so, this technique has quite good compatibility with TOFMS.

However, numerous techniques are available as the second ion acceleration method in which ions are produced continuously. That is, electron impact ionization (EI), chemical ionization (CI), electrospray ionization (ESI), and atmospheric-pressure chemical ionization (APCI).

FIG. 3 conceptually illustrates TOFMS using the orthogonal acceleration method. This is referred to as oa-TOFMS. An ion beam produced from an ion source that generates ions continuously is continuously transported into an orthogonal acceleration region with kinetic energies of tens of eV. In the orthogonal acceleration region, a pulsed voltage of the order of 10 kV is applied such that ions are accelerated in a direction orthogonal to the direction of transportation from the ion source and enter the mass analyzer.

This method has the disadvantage that ions traveling from the ion source to the orthogonal acceleration region during measurement of the time of flight are not measured. The efficiency of utilization in the measurement of time of flight is referred to as the duty cycle.

[Duty Cycle in oa-TOFMS]

In the case of oa-TOFMS, ions continuously travel into the ion acceleration region and only ions lying in the range capable of entering the mass analyzer are measured. The efficiency of utilization of the ions is referred to as the duty cycle and defined by

$$Duty Cycle = \frac{amount of ions used for measurement}{total amount of ions reaching the ion acceleration region} \times 100 ( \% ) \qquad ( 5 )$$

In other words, this can be considered as an ion beam length utilized for measurement out of the ion beam length passed through the ion acceleration region. Let Lₒₐ be the ion length that can be used for the measurement. Let eVᵢₙ be the energy of ions impinging on the ion acceleration region. Let T_{d} be the interval at which TOFMS measurements are made. The duty cycle can be represented as follows

$$Duty Cycle = \frac{{L}_{oa}}{{T}_{d} \sqrt{\frac{2 {zeV}_{i n}}{m}}} \qquad ( 6 )$$

It can be seen from Eq. (6) that the efficiency of utilization can be improved (i) by reducing T_{d}, (ii) by reducing eVᵢₙ, or (iii) increasing Lₒₐ. However, some problems exist in improving the efficiency of utilization. The interval T_{d} is associated with the time of flight. From Eq. (4) it is observed that the mass resolution is improved by increasing the time of flight. Therefore, there is a tradeoff between the duty cycle and improvement of mass resolution.

Reducing the energy eVᵢₙ will produce effective results. In practice, however, the influences of the space charge effects and of charging of electrodes increase, and the ion intensity itself becomes unstable. Therefore, it is impossible to transport ions over a long distance at extremely low values of eVᵢₙ.

The ion length Lₒₐ is associated with the acceptance of TOFMS. In the case of a reflectron TOFMS, the ion length is the size of the detector, normally tens of mm. In the case of multi-pass TOFMS or helical-trajectory TOFMS utilizing an electric sector, the ion length is the effective size of the ion optical system, normally 5 to 10 mm.

In an attempt to alleviate the problem with the duty cycle, a method of placing an ion storage means, which can store ions for a certain period and expel them intermittently, in the stage preceding the stage from which ions are introduced into the pulsed accelerator region has been devised (see U.S. Pat. No. 6,020,586).

In this arrangement, however, a spatial distribution of ionic species is created dependently on the m/z value at distances from the exit position of the ion storage means to the pulsed accelerator region. The position assumed after a lapse of time T from the instant at which ions exit from the ion storage means is given by

$$L = T \sqrt{\frac{2 {zeV}_{i n }}{m}} \qquad ( 7 )$$

where eVᵢₙ is the voltage for expelling of the ions. Thus, the distance determined by the position is inversely proportional to the square of the m/z value. For example, let Lᵢₙ be the distance from the ion storage means to the pulsed accelerator region. Let Lₒₐ be the effective distance of the pulsed accelerator region. The relation between the maximum m/z value (m/z)ₘₐₓ and the minimum m/z value (m/z)ₘᵢₙ of m/z values to be measured can be represented by

$$\frac{{L}_{i n} + {L}_{oa }}{{L}_{i n}} = \frac{T \sqrt{\frac{2 e {V}_{oa}}{{( m / z )}_{m i n}}}}{T \sqrt{\frac{2 {zeV}_{oa}}{{( m / z )}_{m a x}}}} = \sqrt{\frac{{( m / z )}_{ma x}}{{( m / z )}_{m i n}}} \qquad ( 8 )$$

For example, if Lₒₐ/Lᵢₙ=4, it follows that (m/z)ₘₐₓ/(m/z)ₘᵢₙ=25. If (m/z)ₘᵢₙ=50, it follows that (m/z)ₘₐₓ=1250. In consequence, the measurable range of m/z values is restricted. Especially, in the case of a system employing an electric sector having a narrow effective region (acceptance) through which ions can be passed, such as multi-pass TOFMS and helical-trajectory TOFMS, Lₒₐ/Lᵢₙ is small, and the measurable m/z range is severely limited.

### [TOF/TOF Instrument]

As described previously, in a mass spectrometer, ions generated by an ion source are separated according to their in/z value by a mass analyzer and detected. The results are represented in the form of a mass spectrum in which m/z values and relative intensity of each ion are graphed. Information obtained at this time is only about masses. This measurement is herein referred to as an MS measurement in contrast with an MS/MS measurement in which certain ions generated by an ion source are selected by a first stage of mass analyzer (the selected ions are referred to as precursor ions), the ions spontaneously fragment or are urged to fragment, and the generated ions (product ions) are mass-analyzed by a subsequent stage of mass analyzer (MS2). An instrument enabling this is referred to as an MS/MS instrument (FIG. 4).

In MS/MS measurements, the m/z values of precursor ions, the m/z values of product ions generated in plural fragmentation paths, and information about their relative intensities are obtained and so structural information about the precursor ions can be obtained (FIG. 5). An MS/MS instrument capable of making MS/MS measurements is a combination of two of the aforementioned mass spectrometers. Various variations of this type of instrument exist. Furthermore, methods of fragmentation include collision-induced dissociation (CID) using collision with gas, photodissociation, and electron capture dissociation (ECD).

TOF/TOF associated with the present invention is an MS/MS instrument in which two TOFMS units are connected in tandem with an intervening CID-based fragmentation means therebetween. As shown in FIG. 6, in the most common type of TOF/TOF, a linear TOFMS is mounted as a first TOF mass analyzer and a reflectron TOFMS is mounted as a second TOF mass analyzer. This set of mass analyzers is connected with a MALDI ion source.

The feature of TOF/TOF is that fragmentation paths owing to high-energy CID can be observed. The instrument capable of observing such fragmentation paths other than TOF/TOF is an MS/MS instrument in which magnetic MS units are connected in tandem. However, this type of instrument is not widely spread because it is bulky.

High-energy CID has the advantage that when a peptide having tens of amino acids chained together is fragmented, side chain information may be obtained. It is possible to distinguish between leucine and isoleucine having the same molecular weight.

However, high-energy CID has the disadvantages that the fragmentation efficiency is not so high, about 10%, and that the amount of fragment ions in each fragmentation path is small because there are many fragmentation paths.

The present invention is intended to efficiently couple the orthogonal acceleration method used when a continuous ion source or an ion source asynchronous with TOF measurements is adopted to the TOF/TOF technology. This method permits ions generated by various ion sources to be fragmented by a high-energy CID method.

However, because low duty cycle adds to low fragmentation efficiency of TOF/TOF as described previously, it is difficult to perform meaningful MS/MS measurements if the orthogonal acceleration method and TOF/TOF are simply coupled. Especially, in the case of a multi-pass TOFMS or helical-trajectory TOFMS where the flight time of the first TOFMS unit is long and the acceptance of the formed electric sector is low, great problems take place.

### SUMMARY OF THE INVENTION

It is an object of the present invention to provide an instrument in which a continuous ion source and an ion storage means are connected with TOF/TOF continuously. In the MS/MS mode, the function of the ion storage means is enabled. As described already in connection with the related art, the use of the ion storage means permits only ions in a certain range of m/z values to enter the first TOF mass analyzer efficiently. A sufficient amount of precursor ions can be secured by synchronizing the range of m/z values with the precursor ions selected by the first TOF mass analyzer.

Therefore, even in TOF/TOF producing a relatively small amount of fragment ions, MS/MS measurements can be carried out at high sensitivity. At this time, the selected range of m/z values is not spatially spread widely and so this is a method of providing good compatibility with instruments where the time of flight of the first TOF mass analyzer is long and the acceptance of the formed electric sector is low such as multi-pass TOFMS and helical-orbit TOFMS.

The above-described object is achieved by a tandem time-of-flight mass spectrometer associated with the present invention, the spectrometer having: a continuous ion source for ionizing a sample continuously to produce ions; ion storage means for storing the produced ions for a given time and ejecting the stored ions at given timing; an orthogonal acceleration region for receiving the ejected ions in a direction and accelerating the ions in a pulsed manner in a sense crossing the direction in which the ejected ions are received; a first TOF ion optical system for causing the accelerated ions to travel; an ion gate for passing only given precursor ions out of ions mass-separated by the first TOF ion optical system; precursor ion-specifying means for specifying a mass-to-charge ratio of the precursor ions to be measured; ion gate control means for opening and closing the ion gate at timing at which the specified precursor ions pass; fragmentation means for fragmenting the precursor ions passed through the ion gate into product ions; a second TOF ion optical system disposed behind the fragmentation means and operating to mass-separate the product ions; and a detector for detecting ions passed through the second TOF ion optical system. The mass spectrometer further includes a means for finding the time between the instant at which the precursor ions are ejected from the ion storage means and the instant at which the ions arrive at a position inside the orthogonal acceleration region where the ions pass into the following first TOF ion optical system at a maximum passage efficiency. The precursor ions are accelerated in a pulsed manner according to the instant at which the ions arrive at the position giving the maximum passage efficiency.

In one feature of the tandem time-of-flight mass spectrometer, when measurements other than tandem measurements are performed, the ion storage means which is enabled for tandem measurements is disabled.

In another feature of the tandem time-of-flight mass spectrometer, when measurements other than tandem measurements are performed, ions are detected near the end point of the first TOF ion optical system.

In a further feature of the tandem time-of-flight mass spectrometer, when measurements other than tandem measurements are performed, ions are detected within the ion orbit. When tandem measurements are performed, a movable detector that moves out of the ion orbit and passes ions toward the fragmentation means is disposed near the end point of the first TOF ion optical system.

In a yet other feature of the tandem time-of-flight mass spectrometer, there is further provided switching means. The direction of the ion orbit is switched by the switched means in such a way that, when measurements other than tandem measurements are performed, the direction of the ion orbit is directed toward the detector placed near the end point of the first TOF ion optical system and that, when tandem measurements are performed, the direction of the ion orbit is directed toward the fragmentation means.

In a still other feature of the tandem time-of-flight mass spectrometer, the continuous ion source is an electron impact ionization (EI) ion source, a chemical ionization (CI) ion source, an electrospray ionization (ESI) ion source, or an atmospheric-pressure chemical ionization (APCI) ion source.

In an additional feature of the tandem time-of-flight mass spectrometer, the ion storage means is either a quadrupole ion trap including a ring electrode and a pair of end-cap electrodes providing a cover over an opening surface of the ring electrode or a linear ion trap including a multipole element and entrance and exit electrodes disposed at opposite ends of the multipole element.

In a still further feature of the tandem time-of-flight mass spectrometer, the fragmentation means is a collision cell that induces collision-induced dissociation.

In yet additional feature of the tandem time-of-flight mass spectrometer, the first TOF ion optical system provides improved capability of selecting precursor ions by utilizing an electric sector.

A tandem time-of-flight mass spectrometer according to the present invention has: a continuous ion source for ionizing a sample continuously to produce ions; ion storage means for storing the produced ions for a given time and ejecting the stored ions at given timing; an orthogonal acceleration region for receiving the ejected ions in a direction and accelerating the ions in a pulsed manner in a sense crossing the direction in which the ejected ions are received; a first TOF ion optical system for permitting the accelerated ions to travel; an ion gate for passing only given precursor ions out of ions mass-separated by the first TOF ion optical system; precursor ion-specifying means for specifying a mass-to-charge ratio of the precursor ions to be measured; ion gate control means for opening and closing the ion gate at timing at which the specified precursor ions pass; fragmentation means for fragmenting the precursor ions passed through the ion gate into product ions; a second TOF ion optical system, disposed behind the fragmentation means and operating to mass-separate the product ions; and a detector for detecting ions passed through the second TOF ion optical system. The mass spectrometer further includes a means for finding the time between the instant at which the precursor ions are ejected from the ion storage means and the instant at which the ions arrive at a position inside the orthogonal acceleration region where the ions pass into the following first TOF ion optical system at a maximum passage efficiency. The precursor ions are accelerated in a pulsed manner according to the instant at which the ions arrive at the position giving the maximum passage efficiency. Consequently, a tandem time-of-flight mass spectrometer having improved duty cycle can be offered.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

FIG. 1 is a diagram showing a related art linear TOFMS instrument;

FIG. 2 is a diagram showing a related art reflectron TOFMS instrument;

FIG. 3 is a diagram showing a related art orthogonal acceleration mass spectrometer;

FIG. 4 is a block diagram of a related art MS/MS instrument;

FIG. 5 is a conceptual diagram of a related art MS/MS measurement;

FIG. 6 is a diagram showing a related art TOF/TOF instrument;

FIG. 7 is a diagram of a TOF/TOF instrument associated with the present invention; and

FIG. 8 is a schematic diagram of a spatial distribution of ion species in the orthogonal acceleration region of the instrument shown in FIG. 7.

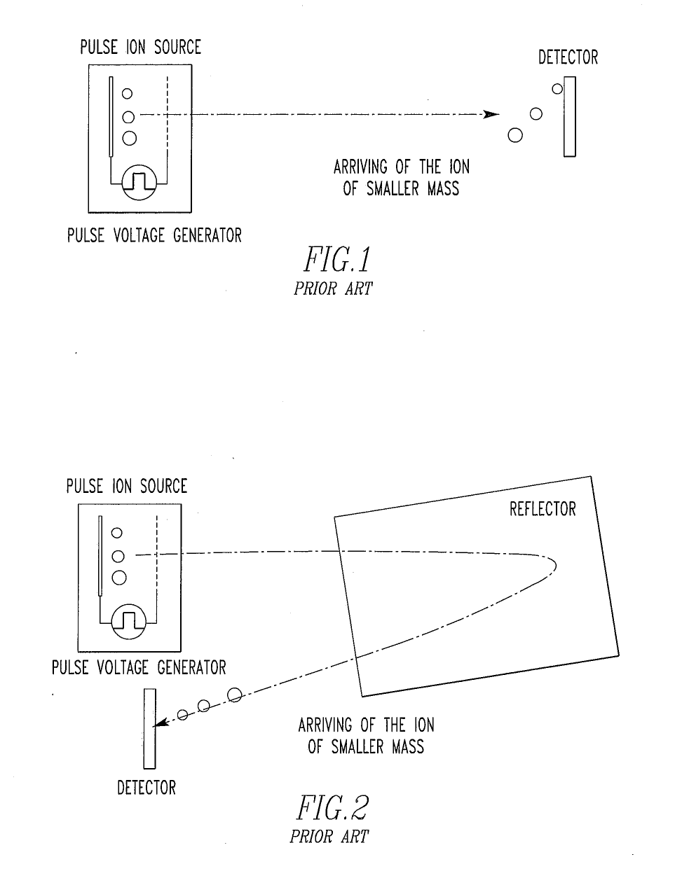

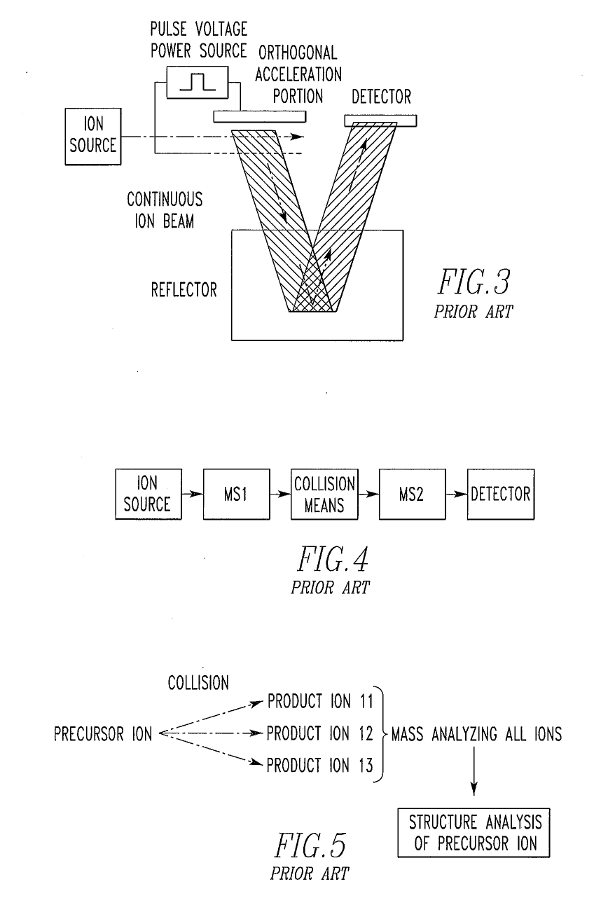

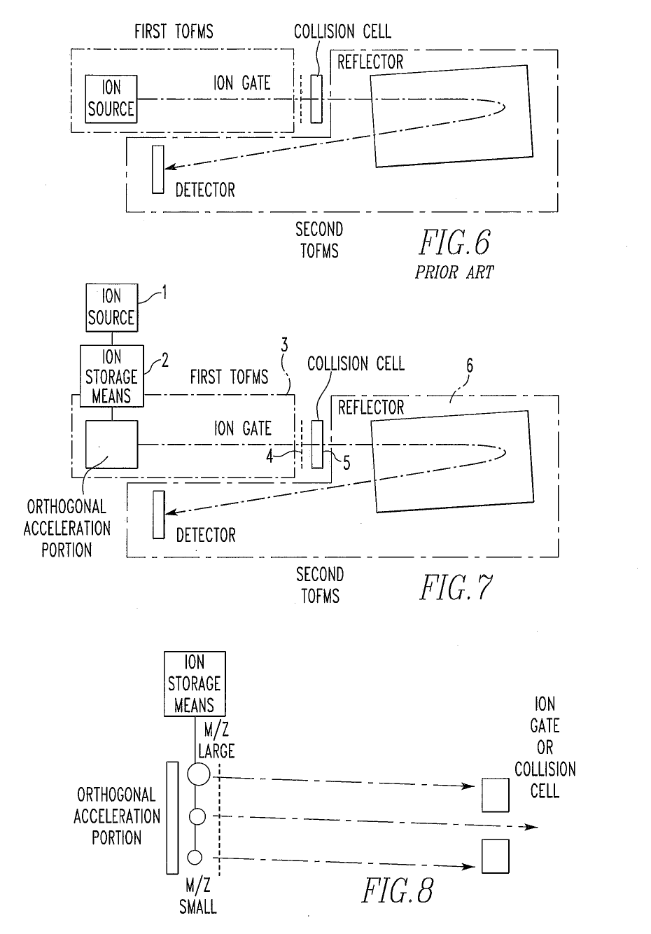

### DESCRIPTION OF THE PREFERRED EMBODIMENTS

The preferred embodiments of the present invention are hereinafter described with reference to FIGS. 7 and 8 of the drawings. Referring to FIG. 7, there is shown a tandem time-of-flight mass spectrometer associated with the present invention. The spectrometer includes a continuous ion source 1 for generating ions continuously, such as an electron impact (EI) ion source, a chemical ionization (CI) ion source, an electrospray ionization (ESI) ion source, or an atmospheric-pressure chemical ionization (APCI) ion source.

The ions generated by the continuous ion source 1 are transported to an ion storage means 2 and stored there. The ion storage means 2 is made of a quadrupole ion trap including a ring electrode and a pair of end-cap electrodes providing a cover over the opening surface of the ring electrode. Alternatively, the ion storage means 2 is made of a linear ion trap including a multipole element and entrance and exit electrodes disposed at the opposite ends of the multipole element.

Ions are stored in the ion storage means 2 for a variable time. The ions stored in the ion storage means 2 are transported to the orthogonal acceleration region of a first TOF mass analyzer (first TOFMS unit) 3 after a lapse of a reference time T₁. Since ions ejected from the ion storage means 2 have different velocities for different m/z values, ions having smaller m/z values are located in deeper locations and ions having larger m/z values are located in more front positions after a lapse of a certain time. Thus, the ions have a spectral distribution through the orthogonal acceleration region (FIG. 8).

The time ΔT₁ taken for precursor ions to be fragmented to go from the ion storage means 2 to a region where the precursor ions can be measured by the first TOF mass analyzer 3 most efficiently is previously calculated. The instrument is so set up that the pulsed voltage applied to the orthogonal acceleration region rises after a lapse of T₁+ΔT₁. The time ΔT₁ is so set that the precursor ions can reach a spatial position in the orthogonal acceleration region that permits the ions to most efficiently pass through the structural objects such as the ion gate 4 and collision cell 5 within the first TOF mass analyzer 3 which become narrower physically along the direction of flight.

This arrival time can be calculated from the m/z value of the selected precursor ions, from the ejection energy from the ion storage means, and from the distance to the spatial position in the orthogonal acceleration region permitting the ions to pass through the structural objects most efficiently. Values calculated for different m/z values may be stored as a table into a storage device, such as a ROM or hard disk. When experiments are made, the values may be read out according to the m/z value of the selected precursor ions and used. Alternatively, prior to experiments, the delay time from ejection of ions from the ion storage means to orthogonal acceleration may be so determined that the height of the mass peak monitored is maximized. Which ever method is adopted, precursor ions are selected as one type out of the ions lying in a range distributed over a distance of tens of mass units about the m/z value.

The precursor ions are accelerated toward the first TOF mass analyzer 3 by the pulsed voltage. The arrival time ΔT₂ taken to arrive at the ion gate is previously calculated from the rise time of the pulsed voltage for the precursor ions. Also, the time ΔT₃ taken to pass through the ion gate is previously calculated from the rise time of the pulsed voltage. The times at which the ion gate is opened and closes are previously set such that the precursor ions can pass through the ion gate during the time from (T₁+ΔT₁+ΔT₂) to (T₁+ΔT₁+ΔT₂+ΔT₃).

Consequently, the ions mass-separated by the first TOF mass analyzer 3 are selected as precursor ions by the ion gate 4. The selected precursor ions enter the collision cell 5 placed behind the first TOF mass analyzer 3. Product ions produced by fragmentation and unfragmented precursor ions are mass-analyzed by a second TOF mass analyzer (second TOFMS unit) 6.

In the case of MS measurements, if ions are stored, mass dependence appears at the intensity distribution on a mass spectrum. Therefore, the function of ion storage which is enabled during MS/MS measurements is disabled.

Generally, a collision cell introduces gas and maintains a locally low vacuum and so has a narrow entrance/exit of the order of millimeters. Therefore, it is conceivable that passages of ions into the following stage will be restricted by this portion. Consequently, during MS measurements, ions may be detected near the end point of the first TOF mass analyzer.

In the case of MS measurements, one method of detecting ions near the end point of the first TOF mass analyzer is to detect ions within the ion orbit. In the case of MS/MS measurements, one method of detecting ions near the first TOF mass analyzer is to mount a movable detector which moves out of the ion orbit and which passes ions toward the collision cell. Another method is to deflect ions by a deflector or electric sector, and the direction of the ion orbit is switched in such a way that the direction is directed towards the ion detector placed near the end point of the first TOF mass analyzer during MS measurements and that the direction is directed towards the collision cell during MS/MS measurements.

The present invention can be widely used in tandem measurements of time-of-flight mass spectrometers.

Having thus described my invention with the detail and particularity required by the Patent Laws, what is desired protected by Letters Patent is set forth in the following claims.

The invention claimed is:

1. A tandem time-of-flight mass spectrometer comprising:
a continuous ion source for ionizing a sample continuously to produce ions;
ion storage means for storing the produced ions for a given time and ejecting the stored ions at given timing;
an orthogonal acceleration region for receiving the ejected ions in a direction and accelerating the ions in a pulsed manner in a sense crossing the direction in which the ejected ions are received;
a first TOF ion optical system for permitting the accelerated ions to travel;
an ion gate for passing only given precursor ions out of ions mass-separated by the first TOF ion optical system;
precursor ion-specifying means for specifying a mass-to-charge ratio of the precursor ions to be measured;
ion gate control means for opening and closing the ion gate at timing at which the specified precursor ions pass;
fragmentation means for fragmenting the precursor ions passed through the ion gate into product ions;
a second TOF ion optical system disposed behind the fragmentation means and operating to mass-separate the product ions; and
a detector for detecting ions passed through the second TOF ion optical system;
wherein there is further provided means for finding the time between the instant at which the precursor ions are ejected from the ion storage means and the instant at which the ions arrive at a position inside the orthogonal acceleration region where the ions pass into the following first TOF ion optical system at a maximum passage efficiency; and
wherein the precursor ions are accelerated in a pulsed manner according to the instant at which the ions arrive at the position giving the maximum passage efficiency.

2. A tandem time-of-flight mass spectrometer as set forth in claim 1, wherein, when measurements other than tandem measurements are performed, the ion storage means which is enabled for tandem measurements is disabled.

3. A tandem time-of-flight mass spectrometer as set forth in claim 2, wherein, when measurements other than tandem measurements are performed, ions are detected near the end point of the first TOF ion optical system.

4. A tandem time-of-flight mass spectrometer as set forth in claim 3, wherein, when measurements other than tandem measurements are performed, ions are detected within the ion orbit, and, when tandem measurements are performed, a movable detector that moves out of the ion orbit and passes ions toward the fragmentation means is disposed near the end point of the first TOF ion optical system.

5. A tandem time-of-flight mass spectrometer as set forth in claim 3, wherein there is further provided switching means that switches the direction of the ion orbit in such a way that, when measurements other than tandem measurements are performed, the direction of the ion orbit is directed towards the detector placed near the end point of the first TOF ion optical system and that, when tandem measurements are performed, the direction of the ion orbit is directed towards the fragmentation means.

6. A tandem time-of-flight mass spectrometer as set forth in claim 1, wherein said continuous ion source is an electron impact ionization (EI) ion source, a chemical ionization (CI) ion source, an electrospray ionization (ESI) ion source, or an atmospheric-pressure chemical ionization (APCI) ion source.

7. A tandem time-of-flight mass spectrometer as set forth in claim 1, wherein said ion storage means is a quadrupole ion trap including a ring electrode and a pair of end-cap electrodes providing a cover over an opening surface of the ring electrode or a linear ion trap including a multipole element and entrance and exit electrodes disposed at opposite ends of the multipole element.

8. A tandem time-of-flight mass spectrometer as set forth in claim 1, wherein said fragmentation means is a collision cell that induces collision-induced dissociation.

9. A tandem time-of-flight mass spectrometer as set forth in claim 1, wherein said first TOF ion optical system provides improved capability of selecting precursor ions by utilizing an electric sector.
